(19) United States
(12) Patent Application Publication
(10) Pub. No.: US 2014/0151440 A1
(43) Pub. Date: Jun. 5, 2014

(54) METHOD FOR MAKING T-BRANCH JOINTS FOR PIPES

(71) Applicant: EFES TEX AG, Lugano (CH)

(72) Inventor: Leo Larikka, Helsinki (FI)

(73) Assignee: EFES TEX AG, Lugano (CH)

(21) Appl. No.: 14/123,496

(22) PCT Filed: May 24, 2012
(86) PCT No.: PCT/FI2012/050496

§ 371 Date: Feb. 21, 2014

(30) Foreign Application Priority Data
Jun. 6, 2011 (FI) 20115544

(51) Int. Cl. B23K 31/02

(52) U.S. Cl. CPC B23K 31/02
USPC 228/171

(57) ABSTRACT

The invention relates to a method for making T-branch joints for pipes. The method comprises making a hole (3) in a pipe (1) to be branched and attaching a branch pipe (2) by welding to the edges of the hole. Welding is conducted from inside the pipes. The hole (3) is made smaller than the internal diameter of the branch pipe (2) with edges (4) of the hole (3) providing a step which extends inside the internal diameter of the branch pipe. The material of the step (4) is melted by internal welding to form part of a weld joint (5).

The invention relates to a method for making T-branch joints for pipes, said method comprising making a hole in a pipe to be branched and attaching a branch pipe by welding to the edges of the hole, the welding being conducted from inside the pipes.

It is prior known to make T-pipe branches by pulling the material of a pipe to be branched to make a branch hole-surrounding collar, to the end of which is attached the end of a branch pipe by internal welding. Reference is made for example to patent specifications U.S. Pat. No. 6,433,307 and EP 1 633 520. However, this prior known method is not suitable for thin-walled pipes, which are left with a welding point which is too thin and weak. This applies particularly to pipes with a wall thickness of less than 1 mm. Even pipes of stainless steel, with a wall thickness of just 1.5 mm, should be capable of being connected by a welding method more reliable than the prior art methods.

An object of the invention is to provide a method for making T-branch joints for pipes, said method being also suitable for connecting thin-walled pipes, such that the welding point becomes sufficiently thick and strong.

This object is achieved by the invention on the basis of characterizing features presented in the appended claim 1.

A particular benefit of the invention is that reinforcing material from the very pipe to be branched can be melted around the joint.

The invention will now be described in more detail with reference to the accompanying drawing, in which

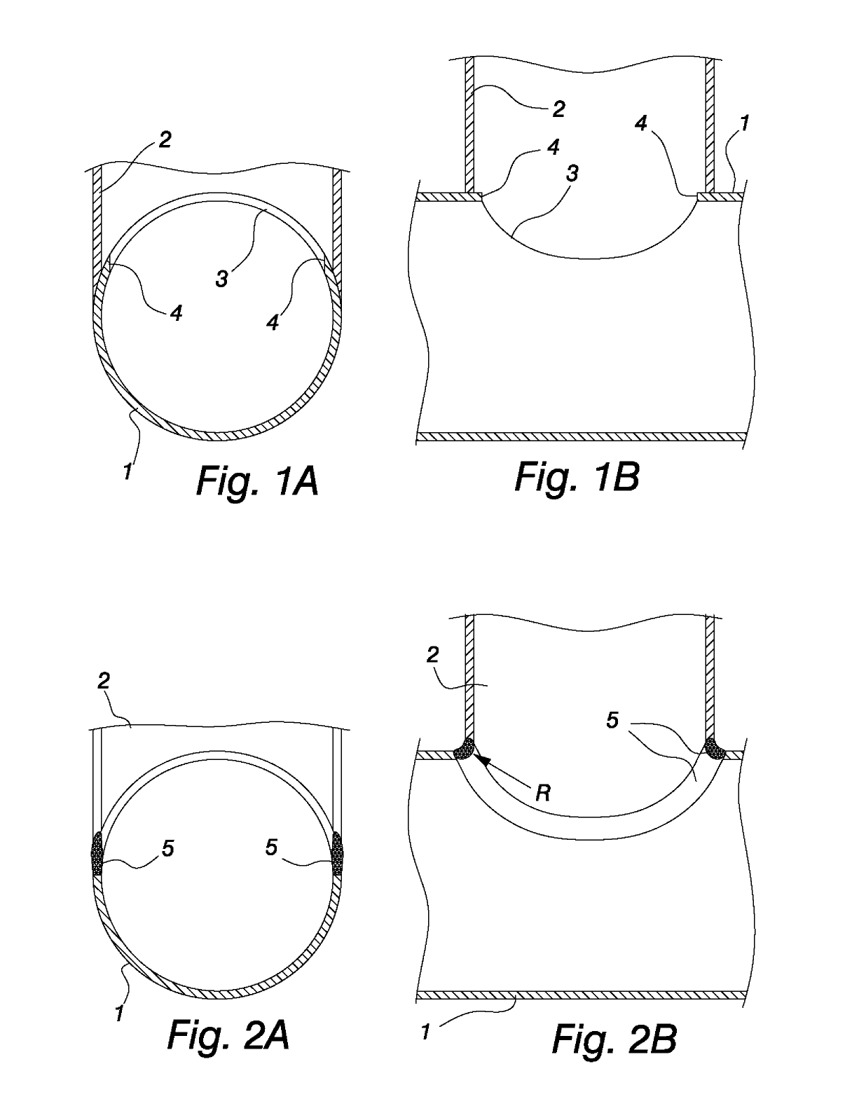

FIG. 1A shows a T-joint assembly for pipes prior to welding, with a pipe 1 to be branched shown in cross-section;

FIG. 1B shows the same as FIG. 1A, but with a pipe 1 to be branched shown in axial section;

FIG. 2A shows a T-branch joint made according to the invention after welding, with a pipe 1 to be branched shown in cross-section, and

FIG. 2B shows the same as FIG. 2A, but with a pipe 1 to be branched shown in axial section.

The method according to the invention comprises making a hole 3 in a pipe 1 to be branched, and attaching a branch pipe 2 by welding to the edges of the hole. Welding is performed from inside the pipe as known from the above-cited patent publications. What is new about the invention is that the hole 3 is made smaller than the internal diameter of the branch pipe 2 with edges of the hole 3 providing a step which extends to a certain extent inside the internal diameter of the branch pipe. Thus, said internal welding enables melting the material of a step 4 to form part of a weld joint 5. Hence, the weld joint 5 becomes even thicker than the wall thickness of the pipes. Thus, the step 4 can be chosen to have such a large extent that the weld joint 5 shall have a thickness that exceeds the wall thickness of the pipes 1 and 2.

The above-described attachment is preceded by shaping the end of the branch pipe 2 to match the outer surface of the pipe 1.

The invention can be applied also with relatively thick-walled pipes, in case a particularly strong connection joint is desired.

1. A method for making T-branch joints for pipes, said method comprising making a hole in a pipe to be branched and attaching a branch pipe by welding to the edges of the hole, the welding being conducted from inside the pipes, wherein the hole is made smaller than the internal diameter of the branch pipe with edges of the hole providing a step which extends inside the internal diameter of the branch pipe, and that the material of the step is melted by said internal welding to form part of a weld joint.

2. A method as set forth in claim 1, wherein step can be chosen to have such a large extent that the weld joint shall have a thickness that exceeds the wall thickness of the pipes.
